(19) United States
(12) Patent Application Publication
(10) Pub. No.: US 2026/0316343 A1
(43) Pub. Date: Oct. 15, 2026

(54) PROCESS FOR THE RECOVERY OF MATERIAL FROM WASTE MANUFACTURED ARTICLES

(71) Applicant: Mauro GARBIN, Vigevano (PV) (IT)

(72) Inventor: Mauro GARBIN, Vigevano (PV) (IT)

(21) Appl. No.: 19/484,816

(22) PCT Filed: May 17, 2024
(86) PCT No.: PCT/IB2024/054808

§ 371 Date: Nov. 14, 2025

(30) Foreign Application Priority Data
May 19, 2023 (IT) 102023000010230

(51) Int. Cl. B29B 17/04; C08J 3/00

(52) U.S. Cl. CPC B29B 17/0404; C08J 3/005; B29B 2017/044; B29B 2017/0484; C08J 2375/04

(57) ABSTRACT

The process for the recovery of material from waste manufactured articles comprises at least the following phases: ⋅—provision of at least 2 one inert material coming from at least one waste manufactured article (2); ⋅—reduction of the inert material into fragments (3) of less than 10 mm in size; ⋅—grinding of the fragments (3) to obtain a powder (4) having a predefined particle size of less than 500 μm; ⋅—mixing of the powder (4) with at least one polyurethane-based material to obtain a composite material (1) having a predetermined rate of polyurethane.

### TECHNICAL FIELD

The present invention relates to a process for the recovery of material from waste manufactured articles.

### BACKGROUND ART

In various and numerous sectors aimed at the production of manufactured articles, the problem of recycling and reuse of waste materials is particularly felt nowadays.

In this regard, it is well known that before manufactured articles can be placed on the market, they must generally be screened by quality control, i.e., subjected to scrupulous analysis aimed at tracing any defects that compromise their functionality and/or appearance.

In this sense, only a part of the manufactured articles, that is, those, having such characteristics so as to make them pass the various controls and inspections, can be introduced into the market and duly marketed, while the remaining part, as it differs from the predefined quality requirements, must necessarily be discarded. The latter manufactured articles are often sent as industrial waste to special disposal sites, where they undergo various treatment processes that enable their raw materials to be recovered, at least partly.

It is clear, however, how this fact goes to waste a huge amount of resources for companies in the sector which, having to discard manufactured articles unsuitable for trade, find themselves forced to deprive themselves entirely of their constituent materials.

What's more, it is worth considering that the high production of waste material stands in stark contradiction to the increasingly stringent regulations governing the amount of waste from industrial processing and its subsequent release into the environment.

In other words, the management of manufactured articles deemed unsuitable for trade to date produces a large number of environmental pollutants that makes it completely unsustainable not only economically, but also ecologically.

### DESCRIPTION OF THE INVENTION

The main aim of the present invention is to devise a process for the recovery of material from waste manufactured articles which allows recovering raw materials in waste manufactured articles and, therefore, cutting down on material waste and the associated costs compared to the state of the art mentioned above.

Within the aforementioned main aim, one object of the present invention is to devise a process for the recovery of material from waste manufactured articles wherein the material thus recovered can be effectively reused in the production of other manufactured articles, that is, without its use resulting in any alteration of the mechanical, physical and techno-aesthetic characteristics of the manufactured articles.

Another object of the present invention to devise a process for the recovery of material from waste manufactured articles which is ecologically sustainable and with a low environmental impact.

Another object of the present invention is to devise a process for the recovery of material from waste manufactured articles which can overcome the aforementioned drawbacks of the prior art within the framework of a simple, rational, easy and effective to use as well as inexpensive solution.

The aforementioned objects are achieved by this process for the recovery of material from waste manufactured articles having the characteristics of claim 1.

### BRIEF DESCRIPTION OF THE DRAWINGS

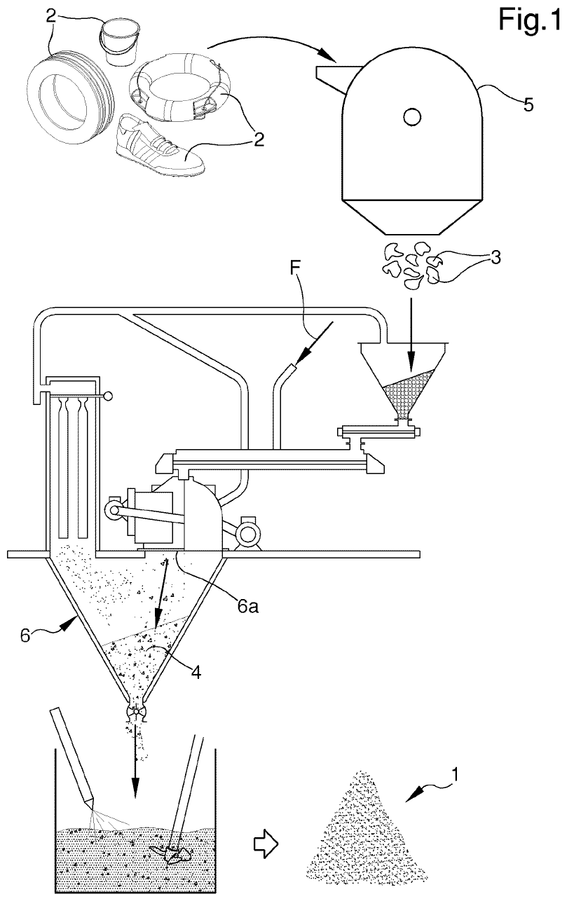

Other characteristics and advantages of the present invention will become more apparent from the description of a preferred, but not exclusive, embodiment of a process for the recovery of material from waste manufactured articles, illustrated by way of an indicative, yet non-limiting example in the accompanying tables of drawings in which FIG. 1 illustrates the process according to the invention by way of example.

### EMBODIMENTS OF THE INVENTION

With particular reference to these figures, reference numeral 1 globally denotes a composite material obtained by means of the process according to the invention. First of all, the process for the recovery of material from waste manufactured articles comprises at least the following phases:
provision of at least one inert material coming from one or more waste manufactured articles 2 (some of which represented simply by way of an example in FIG. 1);
reduction of the inert material into fragments 3 of less than 10 mm in size;
grinding of the fragments 3 to obtain a powder 4 having a predefined particle size of less than 500 μm.

Preferably, the inert material from the waste manufactured articles 2 is of the expanded type.

Specifically, the inert material is selected from the list comprising: polyurethane, ethylene vinyl acetate, rubber, polyvinyl chloride, leather, polyethylene, woven material, coated material or any combination of the above.

Conveniently, the phase of reduction of the inert material into fragments 3 comprises, first of all, at least a step of first reduction, wherein the inert material is coarsely shredded into a plurality of shreds.

This step is preferably performed by shredding means 5, schematically shown in FIG. 1.

For example, the shredding means 5 are of the type of knife mills or similar devices.

The reduction then comprises at least one step of second reduction of the inert material performed subsequently to the first reduction and adapted to obtain the fragments 3 starting from the aforementioned shreds.

The second reduction is done, conveniently, by the use of a fine-grid grinder, not shown in the figures.

In particular, the grids of the fine grinder have a size so as to reduce the size of the shreds until fragments 3 of the desired particle size are obtained.

In this regard, the fragments 3 thus obtained have a size of between 2 mm and 7 mm, better still of between 3 mm and 6 mm, preferably of between 4 mm and 5 mm.

In fact, this size allows the fragments 3 to be effectively ground in the subsequent phase of grinding to obtain the aforementioned powder 4.

In this sense, grinding comprises at least one step of micronizing the fragments 3 wherein the latter are pulverized to the mentioned predefined particle size.

In this regard, the predefined particle size is, precisely, of between 160 μm and 240 μm.

More precisely, the predefined particle size is of between 160 μm and 200 μm. Conveniently, micronizing is carried out at a temperature above −180 °C.

Preferably, micronizing is carried out at a temperature of between −180 °C and 160 °C.

In fact, such temperatures make it possible to greatly increase the structural fragility of the fragments 3 and thus make the grinding of the latter entirely smooth and efficient, reducing thermo-friction.

Conveniently, micronizing comprises at least one sub-step of injection of at least one inert working fluid F adapted to interact with the fragments 3 to reduce them into powder 4.

Preferably, the injected working fluid F comprises nitrogen.

It cannot be ruled out from the scope of this disclosure that the working fluid F may comprise a liquid of a different type.

More preferably, the working fluid F consists of nitrogen.

Since it is, in fact, an inert, nontoxic fluid that is lighter than air, the use of nitrogen is particularly convenient to reduce the fragments 3 into powder 4.

It cannot however be ruled out that the working fluid F may be different from the preferred one just outlined and may, e.g., comprise compressed air and/or another fluid still known to the expert in the field that would, in any case, allow the fragments 3 to be structurally embrittled so that they can be properly ground.

Conveniently, micronizing comprises at least the following sub-steps:
preparing at least one micronizing device 6 provided with at least one grinding chamber 6a;
loading the fragments 3 into the grinding chamber 6a.

In this sense, the sub-step of injection is carried out by blowing the aforementioned working fluid F into the micronizing device 6, e.g., directly into the grinding chamber 6a or through one or more ducts that convey it to the latter (as shown schematically in FIG. 1).

Specifically, the working fluid F is stored in the micronizing device 6 in the liquid phase at −196 °C (at atmospheric pressure).

In this regard, the sub-step of injection can be performed after the preparing sub-step and before the loading sub-step, or it can be performed after the latter.

In other words, the injection of the working fluid F can occur indifferently either before or after loading the fragments 3 into the grinding chamber 6a.

In all cases, as already anticipated, the interaction between the working fluid F and the fragments 3 allows obtaining a powder 4 having the aforementioned predefined particle size.

The process then comprises at least one phase of mixing the powder 4 with at least one polyurethane-based material so as to obtain a composite material 1 having a predetermined rate of polyurethane.

Polyurethane-based material can, therefore, be composed of variable rates of polyurethane.

Preferably, the polyurethane-based material consists of polyurethane.

In other words, the polyurethane-based material is composed of 100% polyurethane.

Conveniently, the aforementioned phase of mixing is implemented with appropriate mixing means 7, illustrated by way of example in FIG. 1.

Preferably, the predetermined rate of polyurethane is of between 50% and 80%. In actual facts, this means that the composite material 1 is composed of 20-50% powder 4 and 50-80% polyurethane.

The possibility cannot however be ruled out of providing for different and, e.g., higher predetermined rates than the one just given.

In this sense, and according to another aspect of the invention, this invention also relates to a composite material 1 obtainable by the process just described.

The composite material 1 in question is thus obtainable starting from the waste material by reduction of the latter into fragments 3 and by subsequent micronizing of the same.

The composite material 1 thus obtained can, therefore, be used in a multiplicity of different technical purposes and uses among which the production of manufactured articles has to be mentioned.

In this regard, and according to a further aspect of the invention, this invention also relates to the use of the composite material 1 obtained from the previously disclosed process for the production of manufactured articles.

In this sense, the composite material 1 derived from the inert material can be profitably used as a constituent element in the production of manufactured articles leading, thus, to significant economic savings about the purchase of new material.

By doing so, i.e., by reusing waste material otherwise destined for landfill, it is clearly possible to drastically reduce the production of industrial waste and, at the same time, align more closely with today's environmental sustainability goals than the state of the art mentioned.

In this regard, it is important to point out that the aesthetic-mechanical properties of manufactured articles obtained by employing the composite material 1 as a constituent material conform to current regulations to those obtained by using only virgin polyurethane, making the use of this material particularly suitable not only for reducing production costs and environmental impact, but also for obtaining qualitatively valuable manufactured articles.

It has in practice been ascertained that the described invention achieves the intended objects.

In particular, the fact is emphasized that the special expedient of providing a phase of mixing the micronized inert material powder with polyurethane makes it possible to obtain a composite material having a particle size and chemical-physical properties such that it can be reused for the production of a multiplicity of different manufactured articles, thus lowering the waste of material and the amount of industrial waste generated compared to the prior art mentioned above.

1. Process for the recovery of material from waste manufactured articles, characterized by the fact that it comprises at least the following phases:
provision of at least one inert material coming from at least one waste manufactured article (2);
reduction of said inert material into fragments (3) of less than 10 mm in size;
grinding of said fragments (3) to obtain a powder (4) having a predefined particle size of less than 500 μm;
mixing of said powder (4) with at least one polyurethane-based material to obtain a composite material (1) having a predetermined rate of polyurethane.

2. Process according to claim 1, characterized by the fact that said inert material is of the expanded type.

3. Process according to claim 1, characterized by the fact that said inert material is selected from the list comprising: polyurethane, ethylene vinyl acetate, rubber, polyvinyl chloride, leather, polyethylene, woven material, coated material or a combination of the above.

4. Process according to claim 1, characterized by the fact that said predetermined rate is of between 50% and 80%.

5. Process according to claim 1, characterized by the fact that said grinding comprises at least one step of micronizing said fragments (3) at a temperature above−180 C.

6. Process according to claim 5, characterized by the fact that said micronizing comprises at least one sub-step of injection of at least one inert working fluid (F).

7. Process according to claim 6, characterized by the fact that said working fluid (F) comprises nitrogen.

8. Process according to claim 1, characterized by the fact that said predefined particle size is of between 160 μm and 240 μm.

9. Process according to claim 5, characterized by the fact that said micronizing comprises at least the following sub-steps:
preparing at least one micronizing device (6) provided with at least one grinding chamber (6a);
loading said fragments (3) into said grinding chamber (6a).

10. Process according to claim 1, characterized by the fact that said fragments (3) have a size of between 2 mm and 7 mm.

11. Process according to claim 1, characterized by the fact that said polyurethane-based material consists of polyurethane.

12. Composite material (1) obtainable from the process according to claim 1.

13. Use of the composite material (1) according to claim 12 for the production of manufactured articles.
